(19) United States
(12) Patent Application Publication
(10) Pub. No.: US 2013/0275317 A1
(43) Pub. Date: Oct. 17, 2013

(54) MANAGING DIGITAL MEDIA OBJECTS

(71) Applicant: ALAMY LIMITED, Oxfordshire (GB)

(72) Inventors: James L. WEST, Oxon (GB); Kaldip S. CHOHAN, Coventry (GB); John S. SCHILIZZI, Reading (GB); Richard G. TAYLOR, Swindon (GB)

(73) Assignee: Alamy Limited, Oxfordshire (GB)

(21) Appl. No.: 13/860,580

(22) Filed: Apr. 11, 2013

Related U.S. Application Data
(60) Provisional application No. 61/622,647, filed on Apr. 11, 2012.

(51) Int. Cl. G06Q 30/00

(52) U.S. Cl. CPC G06Q 30/018
USPC 705/317

(57) ABSTRACT

A computer system and a computer-implemented method for managing digital media objects is described. In at least one embodiment, the system and method may generating a model of an organizational structure comprising a first part and a second part, the model comprising a first structural node representing the first part of the organizational structure and a second structural node representing the second part of the organization structure; generating a licensing model based on licensing rules that apply to the first and second structural nodes, the licensing model comprising digital media object licensing options corresponding to the first structural node and digital media object licensing options corresponding to the second structural node; receiving a search query for digital media objects from a user; determining the user is associated with the first part of the organizational structure; retrieving at least one digital media object that matches the search query from a data repository; determining whether the at least one digital media object has been licensed to the first or second part of the organizational structure; and based on the determination and the licensing model, determining digital media object licensing options available to the user for the at least one digital media object.

### RELATED APPLICATIONS

This application claims the benefit of Provisional Application No. 61/622,647, filed Apr. 11, 2012, which is hereby incorporated by reference herein.

### TECHNICAL FIELD

The systems and techniques described herein relate generally to managing digital media objects.

### BACKGROUND

Organizations such as advertising agencies, publishing houses, corporations, websites, and graphic designers often require the use of images, graphics, documents, text, video, sound, and other media content for specific purposes. Such purposes may include, for example, marketing, advertising, and the dissemination of information through newspapers, magazines, textbooks, webpages, television broadcasts, and other forms of publications. In many cases, media content used by organizations originate from assignment work (e.g., hiring a photographer) and/or from “stock” media content suppliers.

Stock media content refers to pre-existing media content that is available for public or commercial use for free or according to a license. Common licenses include “royalty-free” and “rights-managed” licenses. A royalty-free license generally gives a buyer the right to use media content without the need to pay royalties for each use. For example, once a royalty-free license fee is paid for an image, the image may be used multiple times without paying additional fees. A rights-managed license is typically based on a buyer's use of media content and/or one or more factors including, for example, size, placement, duration of use, and geographic distribution of the media content.

Today, stock media content is generally available as media objects in a digital format through online stock media content suppliers or agencies that operate large commercial websites that allow users to search, browse, purchase, and download digital stock media objects stored in a database. One such agency is Alamy Limited, headquartered in Abingdon, Oxfordshire, United Kingdom. Agencies may own the digital media content outright, and/or may sell the digital media content on behalf of collections, individual photographers, and/or other agencies in exchange for a percentage of any proceeds. Agencies often provide users with the ability to search and/or browse a large collection of stock digital media objects quickly and easily based on, for example, terms and/or license type, Stock digital media objects may then be selected, purchased, and used by a buyer, often subject to the terms of a license.

Organizations that purchase a large number of stock digital media objects often use Digital Asset Management (DAM) systems, which include computer software and hardware systems, to store, organize, search, and access stock digital media objects. DAM systems may be software programs installed on personal computing devices and/or cloud-based systems accessed via the Internet. Conventionally, DAM systems are not provided by online stock media content agencies and do not provide all of the services and opportunities desired by both stock media content buyers and agencies.

### SUMMARY

A method and system for managing digital media objects in an online purchasing environment is described, in at least one embodiment, the method and system may comprise generating a structural model for an organization and generating a licensing model for the organization, wherein generating the licensing model includes applying licensing rules to the structural model. The method and system may also comprise determining digital media object licensing options available to a user for a digital media object based on the licensing model.

### BRIEF DESCRIPTION OF THE DRAWINGS

The accompanying drawings, which are incorporated in and constitute a part of this specification, illustrate various embodiments of the systems and techniques, as described herein, and together with the description, serve to explain the principles of the systems and techniques. In the drawings:

FIG. 1 is a block diagram illustrating a system in accordance with certain embodiments of the disclosed systems and techniques;

FIG. 2 is a block diagram illustrating a system in accordance with certain embodiments of the disclosed systems and techniques;

FIG. 3 is a flow diagram illustrating process steps that may be used with certain embodiments of the disclosed systems and techniques;

FIG. 4 is a flow diagram illustrating process steps that may be used with certain embodiments of the disclosed systems and techniques;

FIG. 5A is a table illustrating a structural model of an organization in accordance with certain embodiments of the disclosed systems and techniques;

FIG. 5B is a graphical depiction of the structural model illustrated in FIG. 5A in accordance with certain embodiments of the disclosed systems and techniques;

FIG. 5C is a table illustrating a structural model of an organization in accordance with certain embodiments of the disclosed systems and techniques;

FIG. 5D is a graphical depiction of the structural model illustrated in FIG. 5C in accordance with certain embodiments of the disclosed systems and techniques;

FIG. 5E is a table illustrating a licensing model in accordance with certain embodiments of the disclosed systems and techniques;

FIG. 6A is a user interface that may be used with certain embodiments of the disclosed systems and techniques; and

FIG. 6B is a user interface that may be used with certain embodiments of the disclosed systems and techniques.

### DETAILED DESCRIPTION

Described herein are systems and techniques for managing digital media objects. The systems and techniques described herein provide various benefits and unique system functionalities, some of which are described below and others which will be readily apparent from the teachings herein. For example, a system incorporating the disclosed techniques may provide a user with the ability to manage digital media objects within a digital media object purchasing environment (e.g., commercial website) in such a way that enables the user to more easily and efficiently purchase, manage, and leverage digital media content across all or part of an organization, all while reducing expenditures. A system incorporating the disclosed techniques, thereby, also provides stock digital media content agencies with the opportunity to provide unique offerings to users.

In certain embodiments, a system incorporating the disclosed techniques may generate and/or store models that represent one or more organizational structures. A model may represent the structure of an organization as a plurality of distinct and hierarchical organizational subparts. For example, an entire organization may be represented as a plurality of sub-organizations, offices, groups and/or teams based on, for example, one or more of the organization's divisional structure (e.g., a division may focus on a specific aspect of an organization), the organization's functional structure, locations, projects, and/or managers.

In these embodiments, licensing rules may be applied across a structural model to generate one or more bespoke licensing models for an organization, in certain embodiments, licensing models may be applied to digital media objects such that, for example, the same or similar price and rights available to the purchasing subpart of an organization for a digital media object are also available to other organizational subparts or the entire organization. Licensing models may also be applied such that, for example, discounts are available to organizational subparts based on one or more triggers. As a specific example, a user may purchase a license granting an organizational subpart the right to use certain digital media objects, which may result in the purchased digital media objects being made available to other subparts of the organization for free or at a discount based on one or more licensing models.

In some embodiments, a system embodying the disclosed techniques may provide a highly customizable digital media object management and collaboration tool through which users associated with different subparts of an organization may, for example, browse, search, filter, and share resources and/or digital media objects, including previously purchased digital media objects, which may be available at a price and with rights determined based on a bespoke licensing model. Other features provided by the tool include, for example, the ability to store and track previously purchased digital media objects, alerts, collaboration features, and digital media object analysis.

Reference will now be made to accompanying figures. Occasionally, the same reference numbers may be used throughout the figures and the following description to refer to the same or similar parts. While several embodiments and features of the systems and techniques are described herein, modifications, adaptations, and other implementations are possible, without departing from the spirit and scope of the systems and techniques. For example, substitutions, additions, or modifications may be made to the components illustrated in the figures, and the methods described herein may be modified by substituting, reordering, or adding steps to the disclosed methods. Accordingly, the following detailed description is not intended to limit the systems and techniques to any specific embodiments or examples.

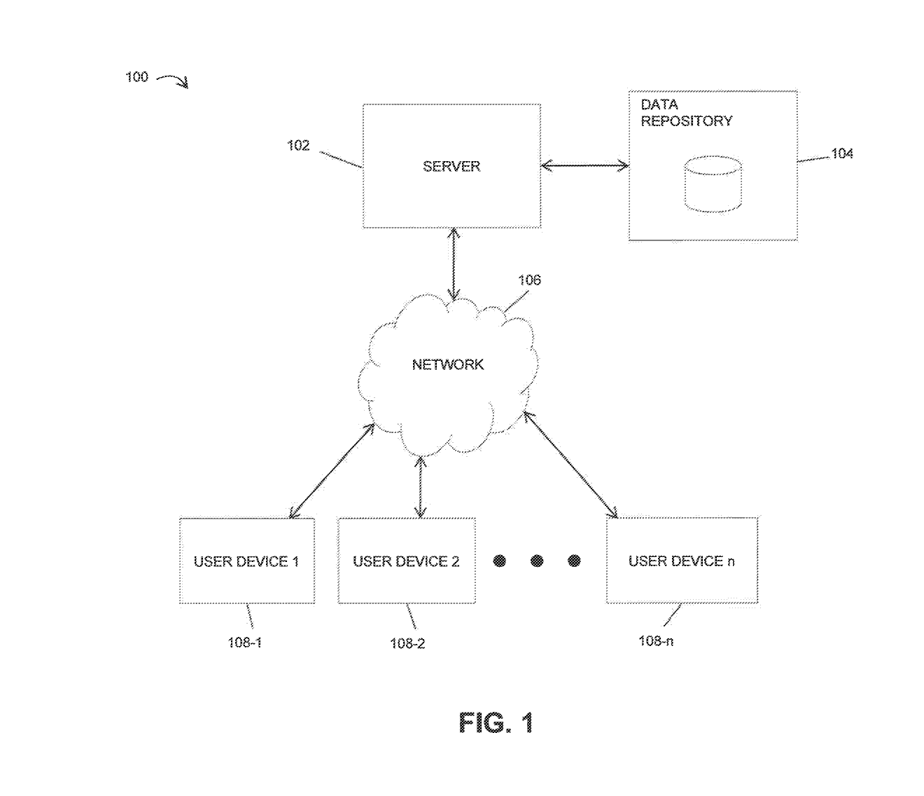

FIG. 1 shows a block diagram of a system that may be used for purchasing and managing digital media objects. As shown in the embodiment of FIG. 1, system 100 may include a server 102, a data repository 104, and user devices 108-1 through 108-n. Server 102 and user devices 108 may communicate through network 106. Network 106 may be any one or more of a variety of networks or other types of communication connections as known to those skilled in the art. Network 106 may include a network connection, bus, or other type of data link, such as a hardwire or other connection known in the art. For example, network 106 may be the Internet, an intranet network, a local area network, or other wireless or other hardwired connection or connections by which server 102 and user devices 108 may communicate.

Server 102 may be, include, or be part of a technology and/or service that manages digital media objects. In various embodiments, server 102 may include, for example, a general purpose computer, a server, a mainframe computer, a computer with a specific purpose of managing digital media objects, or a combination of one or more thereof. For example, server 102 may be a computer server that supports the storage, management, and representation of digital media objects on behalf of and/or according to the needs of one or more organizations. Server 102 may also perform other functions such as, for example, generating bespoke licensing models by applying licensing rules to generated organizational structures for the purpose of determining the cost of digital media objects, as described further below.

User devices 108 may be, include, or be part of any entity that is capable of providing access to server 102 to one or more users via network 106. For example, user devices 108 may include personal computers, laptops, tablet computers, and interactive whiteboards capable of accessing server 102 over the Internet. Server 102 may be accessed using, for example, an Internet web browser, software, or an application programming interface (API) executing on user devices 108.

Data repository 104, which may be communicatively connected to, or part of, server 102, may include one or more files and/or relational and/or non-relational databases that store information that may be accessed, used, and/or managed by server 102. Data repository 104 may be, include, or be part of any logical and/or physical data storage solution. For example, data repository 104 may include one or more data storage devices for storing data. As specific examples, data repository 104 may include volatile or non-volatile, magnetic, semiconductor, tape, optical, removable, non-removable, or other types of storage or computer-readable media. In some embodiments, data repository 104 may store, for example, digital media objects and associated information, information associated with users (e.g., customers or suppliers), structural models, historical licensing data, and licensing models, which may be gathered by, and/or communicated to, server 102. The same or similar data may also be stored in server 102 or one or more other data repositories.

In some embodiments, each digital media object may have a corresponding digital media object profile stored in data repository 104. Digital media object profiles may comprise manually provided information as well as computer-determined information. Manually provided information may include terms for the digital media object, which may be related to the subject matter of the digital media object. Manually provided information may also include factual information about the digital media object such as, for example, the author, date of creation, licensing information, and/or availability of the digital media object. Computer-determined information may include any information determinable, by a computer such as, for example, attributes of the digital media (e.g., size and color). The digital media object profile may also include the activity level and/or history of viewing of the digital media object or related digital media objects (e.g., images originating from the same photographer).

In some embodiments, upon purchase of a digital media object, further metadata such as, for example, organizational metadata, may be automatically added by server 102 to the profile of the digital media object. For example, upon purchase, the profile of a digital media object may comprise metadata indicated the date the digital media object was licensed, the expiration date of the license, and license details. Organizational metadata may be customizable at an organizational or organizational subpart level, enabling the capture of data most useful to the organization or organizational subpart. For example, organizational metadata may indicate how a purchased digital media object is used by an organization or organizational subparts, which subparts of the organization have purchased and/or used the digital media object, and when the digital media object was last used.

In certain embodiments, data repository 104 may also include user profiles for customers and/or suppliers. Each user profile may include the type of customer (e.g., advertising, design, books, newspaper or magazine publisher); the gender of the customer; the profession of the customer; the location and/or region of the customer; organizations and/or organizational subpart(s) to which the customer is associated; user level (e.g., super user, procurement manager, etc.); and historical use data associated with the user. User profiles may also include a “customer importance” level based on the type of customer, account type, the organization and/or organizational subpart(s) the user is associated with, and/or purchase history.

Some embodiments of the disclosed systems and techniques may provide for one or more user levels, each of which may provide a different user interface and/or set of system functionalities to a user based on, for example, a user's role within an organization. Possible user levels may include, for example, account manager, procurement manager, brand manager, organizational subpart manager, super user, basic user, client user, and rookie user. In various embodiments, some users may be of multiple levels; the rights and roles associated with user levels may overlap; the level of a user may or may not align with the user's role within an organization; user levels, and/or the rights and roles associated with user levels, may vary within an organization (e.g., from one subpart to another); and some or all of the functionalities provided by each user level may be delegated and/or made available to other users. It should also be noted that user levels, and the roles and rights associated with the user levels, may differ depending on the embodiment.

An account manager, in some embodiments, may be responsible for managing an organization's, or one or more organizational subparts', digital stock media account. For example, an account manager may be able to upload and configure an organization's structural model; negotiate, select, and modify licenses; and add, remove, or recommend users to/from a group.

A procurement manager, in some embodiments, may be responsible for securing value from an organization's, or one or more organizational subparts', purchases, including digital media object purchases. A procurement manager may be able to, for example, upload and configure an organization's structural model; maintain purchasing policy compliance; set, change, and/or reassign budgets; set budget alerts based on various triggers (e.g., approaching spending limits, anomalous activity, etc.); setup and view expenditure reports (e.g., by organizational subgroup, license type, etc.); and send expenditure reports to other users (e.g., by email, text message, etc.).

A brand manager, in some embodiments, may be responsible for maintaining trends across an entire organization or organizational subpart(s). For example, a brand manager may have access to a visual flight deck, which provides the brand manager with a real-time view of digital media object purchases. A brand manager may also be able to, for example, set alerts that are triggered upon the occurrence of certain purchases and/or downloads (e.g., set an alert that is triggered upon the purchase of a black and white image); select purchased or un-purchased digital media objects that will appear to users or appear as recommendations to users; upgrade licenses; add notes to digital media objects; and configure a system to support brand guidelines by, for example, modifying user homepages to communicate brand guidelines or news, upload brand guidelines to configure and/or limit searching capabilities and/or search results, and upload digital media objects for the purpose of allowing the system to analyze the digital media object to determine brand guidelines.

An organizational subpart manager, in some embodiments, may have access to the same or a similar set of functionalities available to one or more other user levels but only for one or more organizational subparts. The available functionalities may, for example, be defined by an account manager and/or procurement manager.

A super user, in some embodiments, may be an individual that, for example, has a greater understanding of an organization's brand guidelines, is a brand influencer, and/or is a skillful searcher of digital media objects. Thus, a super user may be given greater purchasing rights (e.g., a super user can purchase digital media objects for an entire organization, has less purchasing restrictions, etc.) and greater system visibility (e.g., a super user may be able to see expired licenses and the activity of all users).

A basic user, in some embodiments, has the ability to, for example, set up projects and contribute to projects (e.g. digital media object selection and commentary, chat, etc.) in addition to searching, purchasing, and downloading digital media objects. A client user, in some embodiments, may be able to, for example, see projects, score and/or rank digital media objects, comment on digital media objects, and/or chat about projects and/or digital media objects.

A rookie user, in some embodiments, may be a user, for example, whose downloads and/or purchases must be approved by a designated user, or a user with a certain user level, who may be alerted upon the occurrence of a triggering event (e.g., purchase or download) or at regular time intervals (e.g., daily).

In some embodiments, a user profile may also indicate whether a user is a “leader” or a “follower.” In some cases, users may select to be a leader or a follower. In other cases, users may automatically or manually be designated as a leader or a follower based on, for example, user level and/or historical activity. A leader may be, for example, a skilled searcher of digital media objects or a manager. A follower may be, for example, a less skilled searcher of digital media objects. A leader may have greater rights comparable to the rights of a superuser while a follower may have limited rights. For example, a follower may only be able to purchase digital media objects approved by a leader or other user. Followers may also be able to follow the activities of leaders.

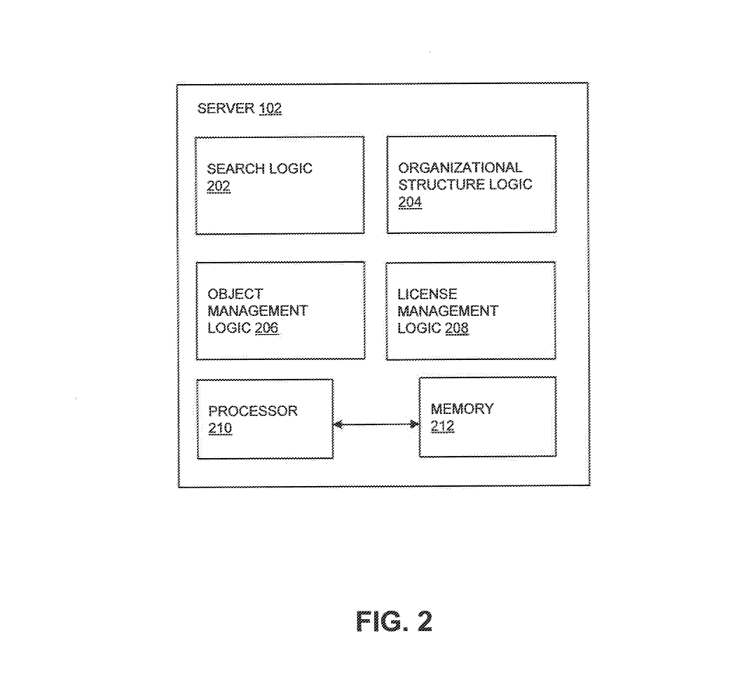

Referring to FIG. 2, shown is a component diagram of server 102 consistent with an embodiment of the systems and techniques disclosed herein, Server 102 as shown includes software and/or hardware components such as search logic 202, organizational structure logic 204, object management logic 206, and license management logic 208, Components 202, 204, 206, and 208 may communicate with one another and other components or devices, such as data repository 104, via one or more communication channels and/or interfaces (not shown). Particular embodiments of server 102 may also provide an interface that allows an administrator to communicate with and manage server 102 and/or components 202, 204, 206, and 208. For example, the interface may give an administrator the ability to calibrate various parameters of server 102 and/or components 202, 204, 206, and 208.

In this embodiment, server 102 may further comprise a processor 210 coupled to a memory 212, Processor 210 may comprise a microprocessor, a microcontroller, an application-specific integrated circuit (ASIC), a field programmable gate array (FPGA), or other type of processing circuitry, as well as portions or combinations of such circuitry elements. Memory 212 may be viewed as an example of what is more generally referred to as a “computer program product” having executable computer program code embodied therein in accordance with the discussed techniques. Memory 212 may be, include, or be part of volatile or non-volatile, magnetic, semiconductor, tape, optical, removable, non-removable, or other types of storage or computer-readable media, in any combination, Other examples of computer program products capable of embodying aspects of the disclosed invention may include, for example, optical or magnetic disks, and USB flash drives.

Search logic 202, organizational structure logic 204, object management logic 206, and license management logic 208 may be implemented in whole or in part in the form of one or more software programs loaded into memory 212 and executed by processor 210 to perform one or more processes consistent with the systems and techniques disclosed herein. Memory 212 and processor 210 may also load and execute other programs and logic that perform other processes such as, for example, programs that provide communication support. Memory 212 may also be configured with an operating system (not shown) that performs functions well known in the art when executed.

It should be noted that the particular examples of hardware and software that may be included in systems 100 and 200 are described herein in more detail, and may vary with each particular embodiment. For example, systems in accordance with the techniques such as systems 100 and 200 may comprise more than one of each of the components specifically shown in FIG. 1 and FIG. 2. Thus, it is to be appreciated that given embodiments of systems 100 and 200 may include multiple instances of server 102, data repository 104, and network 106, and in regards to system 200, multiple instances of processor 210, memory 212, search logic 202, organizational structure logic 204, object management logic 206, and license management logic 208, although only single instances of such components are shown in simplified system diagrams 100 and 200 for clarity of illustration. Other software and/or hardware components of a type known to those skilled in the art may also or instead be incorporated into systems 100 and 200. It should also be noted that in some embodiments, functionalities and data provided by the components shown in systems 100 and 200 may be provided by other components shown or not shown in systems 100 and 200, or may not be provided at all.

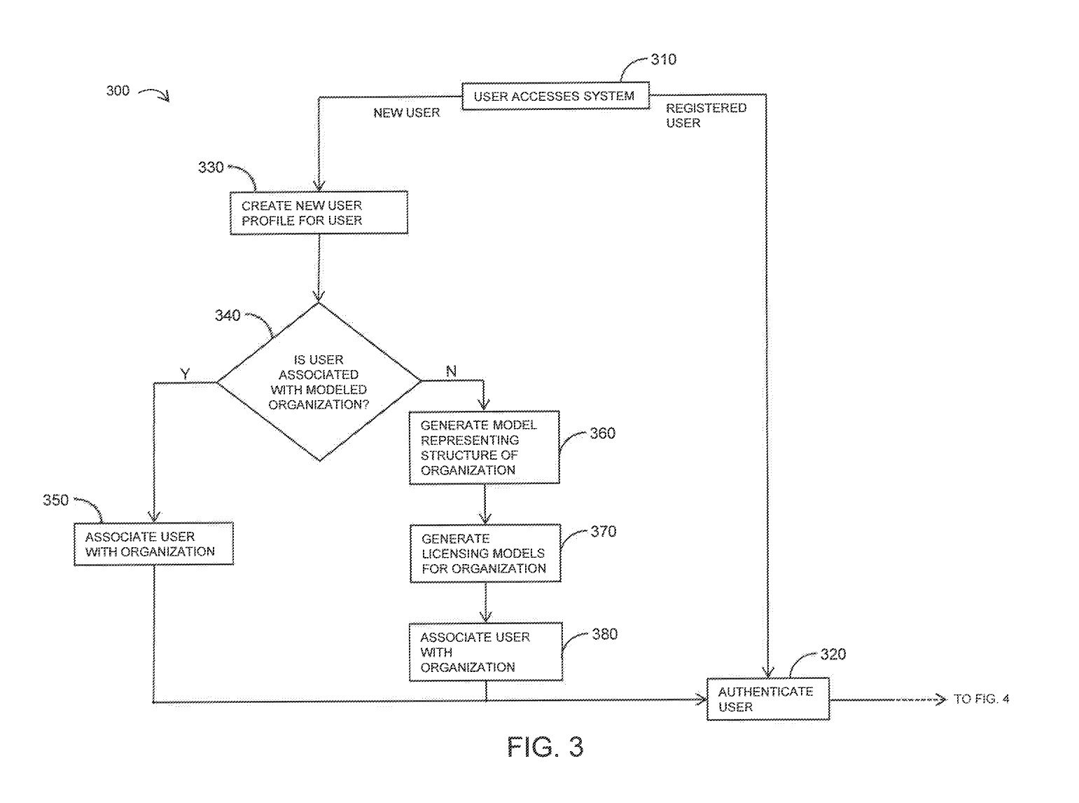

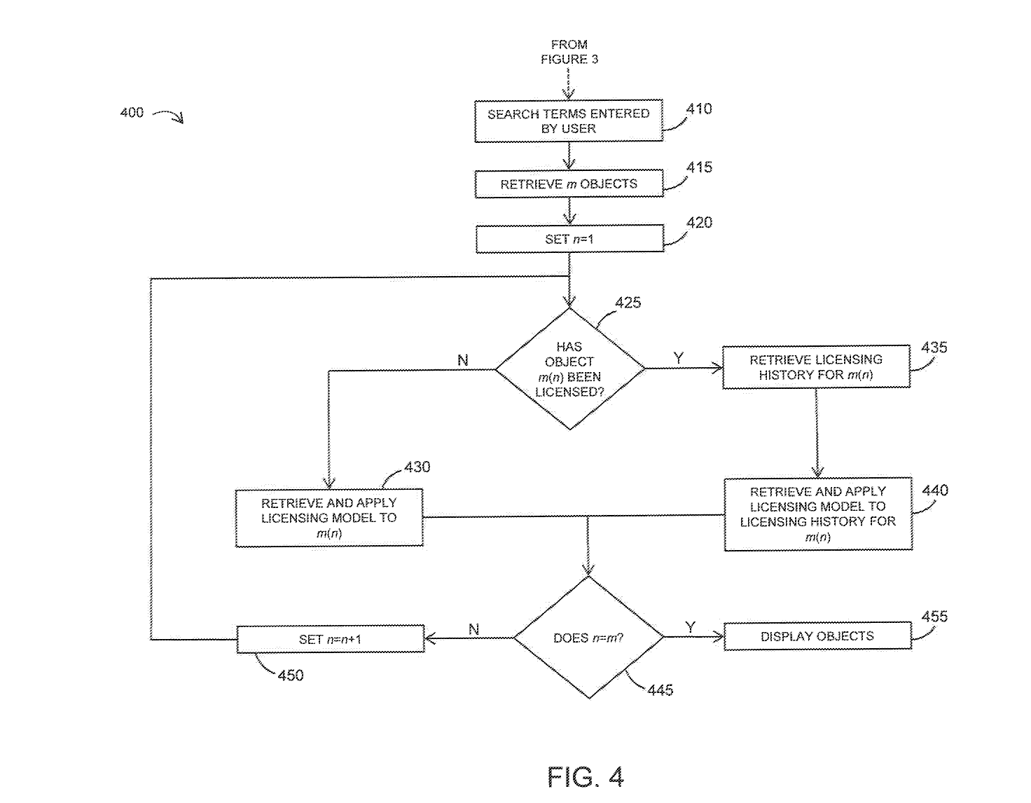

Referring now to FIG. 3 and FIG. 4, flow diagrams 300 and 400 illustrate process steps that may be used with certain embodiments of the systems and techniques described herein. For example, the process steps shown in flow diagrams 300 and 400 may be implemented within system 100 of FIG. 1.

At step 310 of FIG. 3, a user associated with an organization may access a system incorporating the disclosed techniques, such as server 102 of FIG. 1. The user may access the system via one or more system access points available using a user device, such as devices 108 of FIG. 1. System access points may include websites, software applications, or any other moans through which the user can connect to the system via a user device. In some embodiments, accessing the system requires the user and/or organization or organizational subpart be registered to use the system.

In an embodiment where system registration is required, if the user previously registered to access the system, the returning user may be identified and authenticated by the system at step 320. Identification and authentication may occur, for example, upon the user providing credentials unique to the user (e.g., username and password) and/or associated organization, or automatically based on such credentials, upon reaching a system access point. Typically, authentication includes verifying the credentials provided by a user against credentials stored by the system and associated with the user and/or organization or organizational subpart. In some embodiments, credentials may be created for a user and/or organization or organizational subpart during a system registration process as further described below.

In these embodiments, if the user has never accessed the system, a user profile may be created by the system for the new user at step 330. User profiles may be created during a system registration process during which the user may provide various pieces of information including, for example, the user's name, age, address, and job title, as well as the name, address, and structural information of the organization to which the user is associated. The user may also provide information indicating which subpart(s) of the organization the user is associated with, if any. In some embodiments, the information may be stored, for example, in one or more databases contained within data repositories (e.g., data repository 104 of FIG. 1).

In other embodiments, users may be registered upon the associated organization or organizational subpart being registered to use the system. In these embodiments, information for multiple users may be provided to the system for the creation of a user profile for each of the multiple users. Organizational information may also be provided to the system at this time.

At step 340, the system may determine whether the new user is associated with an organization for which a structural model was previously generated by the system. In some embodiments, the determination may be made by organizational structure logic 204 of FIG. 2 based on information provided by the user during registration such as, for example, the name of the organization, the domain name of an e-mail address, or other organization identifying information. The information may be used, for example, by organizational structure logic 204 to query a database containing information pertaining to organizations, including information indicative of whether a structural model has been generated by the system for such organizations.

If the new user is associated with an organization for which a structural model was previously generated by the system, the system may create and store an association between the user and the organization, or an organizational subpart, at step 350. In some embodiments, users may be registered and associated with an organization or organizational subpart by users with a certain user level such as, for example, account manager. In other embodiments, authorization by users with a certain user level may be required before a user is registered and associated with an organization and/or organizational subpart.

If the user is associated with an organization for which a structural model was not previously generated by the system, the system may generate a model at step 360 that represents the structure of the organization to which the user is associated using, for example, organizational structure logic 204 of FIG. 2. In various embodiments, the system may, for example, obtain information necessary for generating the model from the user, users with a certain user level (e.g., an account manager), publicly available resources, or a combination thereof. In some embodiments, models may be generated at various times including, for example, before, during, or after user registration.

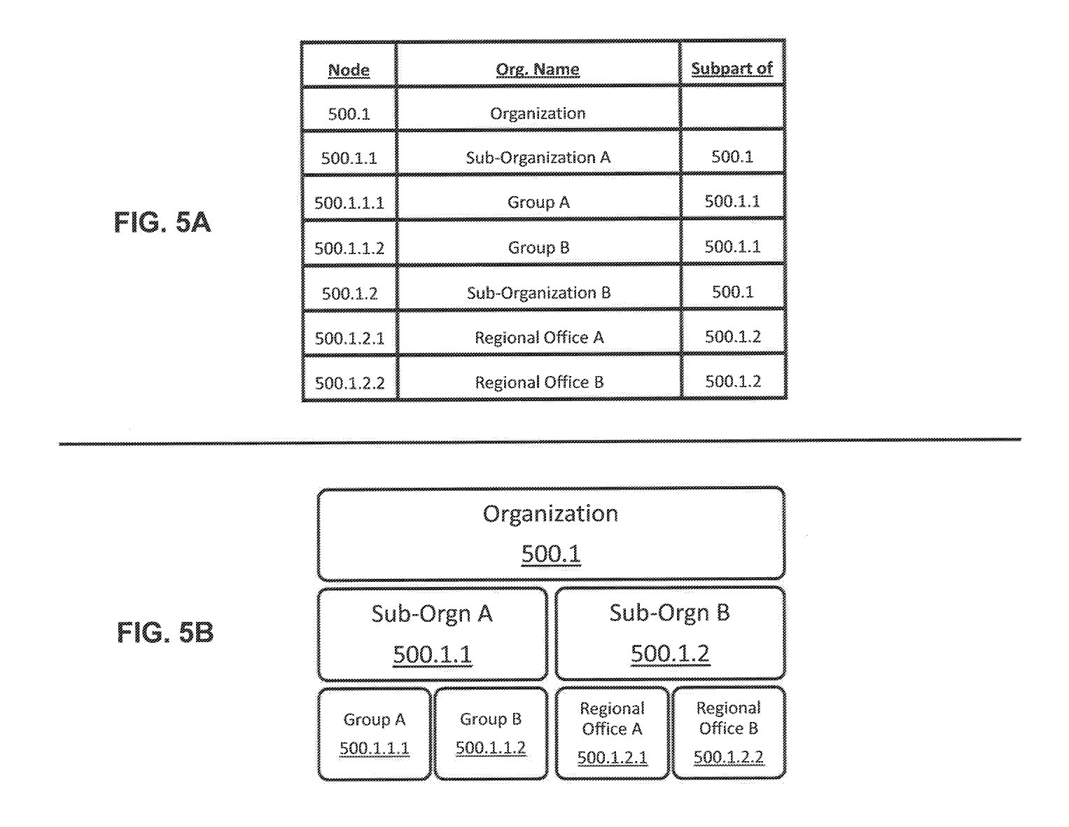

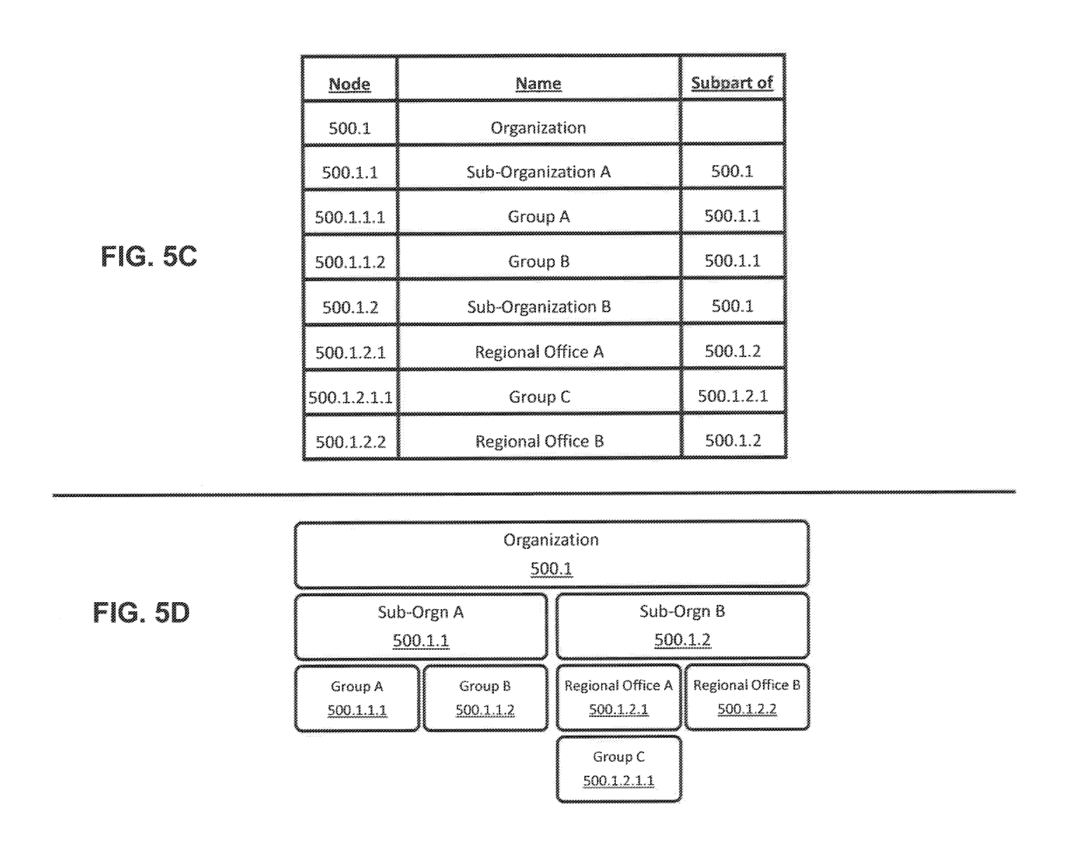

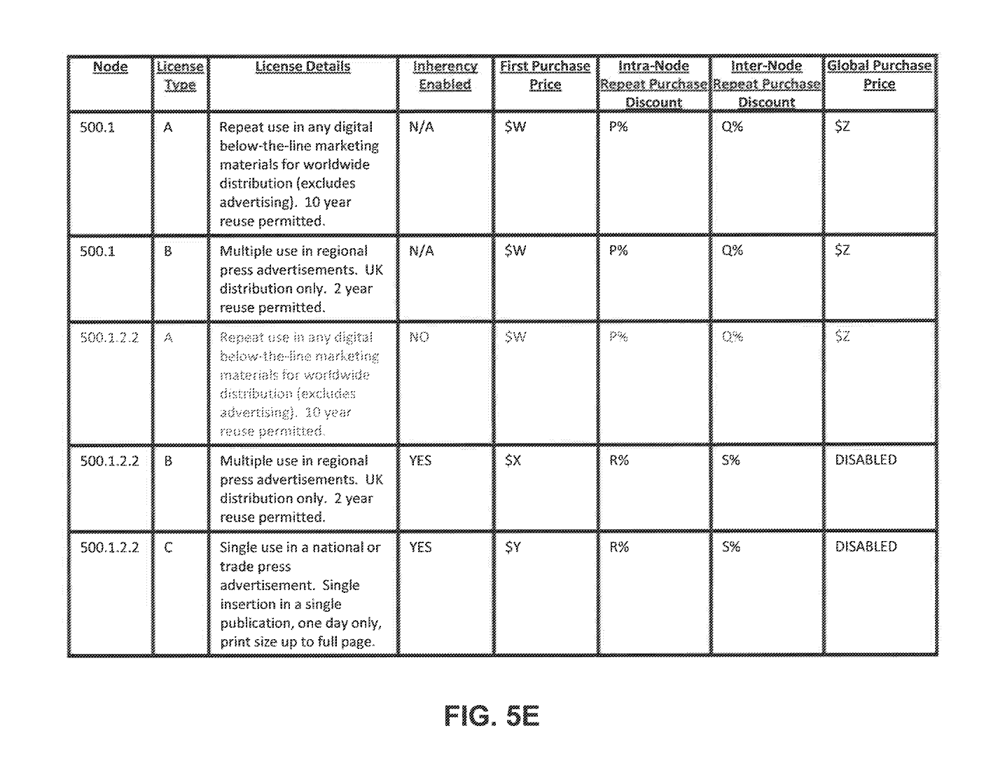

In some embodiments, structural models may be programmatically generated, stored, and maintained by the system using, for example, one or more data modeling techniques known to those skilled in the art. For example, as illustrated in FIG. 5A, a structural model may be programmatically generated, stored, and maintained by the system using one or more data structures comprising a set of interrelated data nodes, each node representing either the entire organization or a subpart of the organization. Each node may also include its relationship to one or more other nodes.

FIG. 5B graphically depicts the structural model illustrated in FIG. 5A. The graphical depiction illustrates the hierarchical relationships between the organization and its subparts, progressing from top to bottom. As shown, the top-level box represents an entire organization, Organization 500.1. Sub-Organization A 500.1.1 and Sub-Organization B 500.1.2 represent subparts of Organization 500.1. For example, Sub-Organizations A 500.1.1 and B 500.1.2 may represent two separate product divisions of Organization 500.1. Regional Office A 500.1.2.1 and Regional Office B 500.1.2.2 represent subparts of Sub-Organization B 500.1.2. For example, Regional Offices A 500.1.2.1 and B 500.1.2.2 may represent two geographically separate sales offices for the product division represented by Sub-Organization B 500.1.2. Also shown in FIG. 5B are Groups A 500.1.1.1 and B 500.1.1.2, which represent subparts of Sub-Organization A 500.1.1. For example, Groups A 500.1.1.1 and B 500.1.1.2 may represent two separate product design groups within the product division represented by Sub-Organization A 500.1.1.

In some cases, the structural model of an organization to which a user is associated may have been previously generated by the system but the subpart to which the user is associated is not represented by the previously generated structural model. For example, a user associated with the organization who's structural model is illustrated in FIGS. 5A and 5B may be associated with Group C, a subpart of Organization 500.1 not represented by the previously generated structural model, as illustrated in FIGS. 5A and 5B. Group C may be, for example, a regional marketing team. In this example, in some embodiments, information provided by the user may be used by the system (e.g., organizational structure logic 204) to edit the structural model of the organization as illustrated in FIGS. 5A and 5B to add Group C 500.1.2.1.1 as a subpart of Regional Office A 500.1.2.1, resulting in the structural model illustrated in FIGS. 5C and 5D. In other embodiments, only users of a certain level (e.g., account manager) may be able to edit an organization's structural model or such users may be required to authorize other users to edit an organization's structural model.

At step 370, licensing rules may be applied to the organizational structure to generate one or more bespoke licensing models for the organization and/or for one or more organizational subparts. In certain embodiments, licensing models may be venerated by license management logic 208. In some embodiments, licensing rules may be based on predefined or negotiated agreements made available to organizations. Such agreements may be organization-wide arrangements that detail various licenses and how the licenses apply across an organization. For example, an agreement may specify the prices an organization, or one or more organizational subparts, must pay for various digital media objects as well as possible discounts available to the organization or one or more organizational subparts. An agreement may also specify, for example, one or more of the purchase price for the first use of a digital media object by an organization, any discounts for subsequent uses of the digital media object by the organization, discounts available to subparts of the organization to purchase the digital media object, to which subparts the discount is available, the circumstances under which the discounts apply, for how long the discounts are available, the purchase price for a global license to use the digital media object, etc.

In some embodiments, licensing rules may be applied to the organizational model in such a way that licenses that are available at one level of an organization may be inherited by one or more lower-levels of the organization (e.g., an organizational subpart). In some cases, inherited licenses may be superseded at a lower level. Whether licenses are inherited or superseded may depend on, for example, the predefined or negotiated agreements and/or any subsequent agreements.

For example, FIG. 5E illustrates a licensing model resulting from licensing rules being applied across the structural model illustrated in FIGS. 5C and 5D. In some embodiments, the rows in the table of FIG. 5E may represent, for example, database records, each row representing a different license available to the organization or organizational subpart identified by a “node” value in the table. Details for a license may be provided as one or more values in a row. As shown, the following values are included in the licensing model of FIG. 5E: license type, license details, inherency enabled, first purchase price, intra-node repeat purchase discount, inter-node repeat purchase discount, and global purchase price.

In some embodiments, the “license type” value may be an identifier for a type of license, which may be based on the “license details” value in the table of FIG. 5E. For example, license type A in the table of FIG. 5E grants Organization 500.1 (i.e., node 500.1) repeat use of a digital media object in any digital below-the-line marketing materials for worldwide distribution (excluding advertising), with reuse permitted for ten years, License type B in the table of FIG. 5E grants Organization 500.1 multiple use of a digital media object in regional press advertisements, UK distribution only, with reuse permitted for two years. License type C in the table of FIG. 5E grants Regional Office B 500.1.2.2 (i.e., node 500.1.2.2) single use of a digital media object in a national or trade press advertisement, limited to a single insertion of the digital media object in a single publication, for one day only, and with the print size being up to one full page. The number of license types and the licensing details may vary depending on the embodiment and/or needs of the organization.

In certain embodiments, the “inherency enabled” value may indicate whether a license is inherited from another node (e.g., a higher-level node). If a license is inherited, all of the values for the inherited license may appear as an entry for the inheriting node, unless any of those value are superseded. If a license is not inherited, the license may not be available to the would-be inheriting node.

In some embodiments, the “first purchase price” value may be the price to be paid by the organization or organizational subpart for the first use of a digital media object in accordance with the terms of the license defined by the values provided in the corresponding row in the table of FIG. 5E. The “intra-node repeat purchase discount” value may be the discount applied to subsequent purchases of the digital media object in accordance with the same license terms by the organization or organizational subpart. As shown, the intra-node repeat purchase discount value only applies to repeat purchases of the digital media object by the organization or organizational subpart that made the first purchase of the digital media object. The “inter-node repeat purchase discount” value may be the discount applied to subsequent purchases of the digital media object in accordance with the same license terms by an organization or organizational subpart other than the organization or organizational subpart that made the first purchase of the digital media object. For example, in at least one embodiment, the inter-node repeat purchase discount may apply to repeat purchases by any organization or organizational subpart other than the organization or organizational subpart that made the first purchase of the digital media object. In another embodiment, the inter-node repeat purchase discount value may only apply to repeat purchases of a digital media object by one or more organizational subparts represented by lower-level nodes than the organization or organizational subpart that made the first purchase of the digital media object. In yet another embodiment, the inter-node repeat purchase discount value may only apply to repeat purchases of a digital media object by any organization or organizational subpart as predetermined in predefined or negotiated agreements. The “global purchase price” value may be the price to be paid by the organization or organizational subpart for global use of a digital media object in accordance with the terms of the license defined by the values provided in the corresponding row in the table of FIG. 5E.

In some embodiments, various other licensing model values and/or discounts may also or instead be provided. For example, in certain embodiments, a licensing model value may indicate that a license is available to an organization, or one or more organizational subparts, to use a digital media object at a discount under terms different than those given to the organization or organizational subpart that made the first purchase of the digital media object. In certain embodiments, various licensing model values may also indicate under which circumstances discounts are available and for how long. For example, discounts may not be available until a certain number of purchases of a digital media object have been made. It should be noted that, in some embodiments, discounts such as, for example, the discount represented by the inter-node repeat purchase discount value, may not be provided as a licensing model value but instead is applied during generation of the licensing model such that the discount is represented by other licensing model values (e.g., “first purchase price” value). It should also be noted that, in certain embodiments, licensing model values may differ among nodes.

As shown in FIG. 5E, two types of licenses are available thr users associated with node 500.1 (i.e., Organization 500.1), license type A and license type B. Node 500.1.2.2 (i.e., Regional Office B) is a subpart of node 500.1.2 (i.e., Sub-Organization B), which is a subpart of node 500.1. Therefore, users associated with node 500.1.2.2 may inherit the license types of node 500.12, which may inherent the license types of node 500.1, unless inherency is disabled for a particular license type and node. As shown in FIG. 5E for node 500.1.2.2, inherency is disabled for license type A. Therefore, license type A is not available to users associated with node 500.1.2.2. Inherency is enabled for license type B for node 500.1.2.2, but the first purchase price, intra-node repeat purchase discount, inter-node repeat purchase discount, and global purchase price values have been superseded. Also available to users associated with node 500.1.2.2 is license type C.

Once the structural model and licensing models are generated at steps 360 and 370, respectively, the system may store an association between the user and the organization at step 380, as discussed above for step 350. In some embodiments, the user may then be authenticated at step 320.

Referring now to flow diagram 400 of FIG. 4, at step 410 the user may enter search terms into a search engine for the purpose of searching digital media objects. For example, the system may use search logic 202 of FIG. 2 to search digital media objects stored in a data repository based on the entered search terms.

At step 415, the system may retrieve a number m of digital media objects that match the entered search terms. Matches may be determined based on metadata associated with the digital media objects. Metadata may include, for example, the author, date, color, terms related to the subject of the digital media object, and other metadata, including manually provided metadata and computer-determined metadata such as, thr example, organization metadata.

At step 425, beginning with the first retrieved digital media object m(n), where n=1 (step 420), it may be determined whether digital media object m(n) has been licensed to all or part of the organization using, for example, license management logic 208 of FIG. 2. For example, license management logic 208 may query one or more databases to determine whether digital media object m(n) has been licensed to all or part of the organization. If it is determined that digital media object m(n) has not been licensed to all or part of the organization, the process as illustrated in FIG. 4 continues at step 430. If it is determined that digital media object m(n) has been licensed by all or part of the organization, the process as illustrated in FIG. 4 continues at step 435.

If digital media object m(n) has not been licensed to all or part of the associated organization, the organization's licensing model is retrieved and applied to digital media object m(n) at step 430. For example, referring to FIGS. 5C, 5D, and 5E, if the user is associated with node 500.1.2.2 (i.e., Regional Office B), licensing details for license types B and C for node 500.1.2.2 are obtained from the licensing model and applied to digital media object m(n) at step 430. In some embodiments, applying the licensing details to digital media object m(n) is done in such a way as to inform the user of the various licensing options available to the user for digital media object m(n) upon display of digital media object m(n), or any information pertaining to digital media object m(n). For example, the various licensing options available to the user for digital media object m(n) may be presented to the user upon the user selecting digital media object m(n) from a set of digital media objects returned from a search. In some embodiments, step 430 may include temporarily storing the licensing details until digital media object m(n), or information pertaining to digital media object m(n), is to be displayed to the user, It should be noted that, in some embodiments, step 430 may not be performed until the point at which digital media object m(n), or information pertaining to digital media object m(n), is to be displayed to the user (e.g., step 455).

If at step 425 it is determined that digital media object m(n) has been licensed to all or part of the organization, the licensing history for digital media object m(n) may be retrieved at step 435. In some embodiments, licensing history may include, for example, which organization and/or organizational subpart(s) licensed digital media object m(n), under which license type digital media object m(n) was licensed, the number of purchases of digital media object m(n) under the license type, and any other information associated with the licensing of digital media object m(n).

At step 440, the licensing model associated with the organization may be retrieved and applied to the licensing history retrieved at step 435 for digital media object m(n). In some embodiments, applying the licensing details contained in the licensing model to digital media object m(n) is done in such a way as to inform the user of the various licensing options available to the user for digital media object m(n) upon display of digital media object m(n), or any information pertaining to digital media object m(n). For example, the various licensing options available to the user for digital media object m(n) may be presented to the user upon display of digital media object m(n) as part of a set of digital media objects returned from a search. In some embodiments, step 440 may include temporarily storing the licensing details until digital media object m(n), or information pertaining to digital media object m(n), is to be displayed to the user. It should be noted that, in some embodiments, step 440 may not be performed until the point at which digital media object m(n), or information pertaining to digital media object m(n), is to be displayed to the user (e.g., step 455).

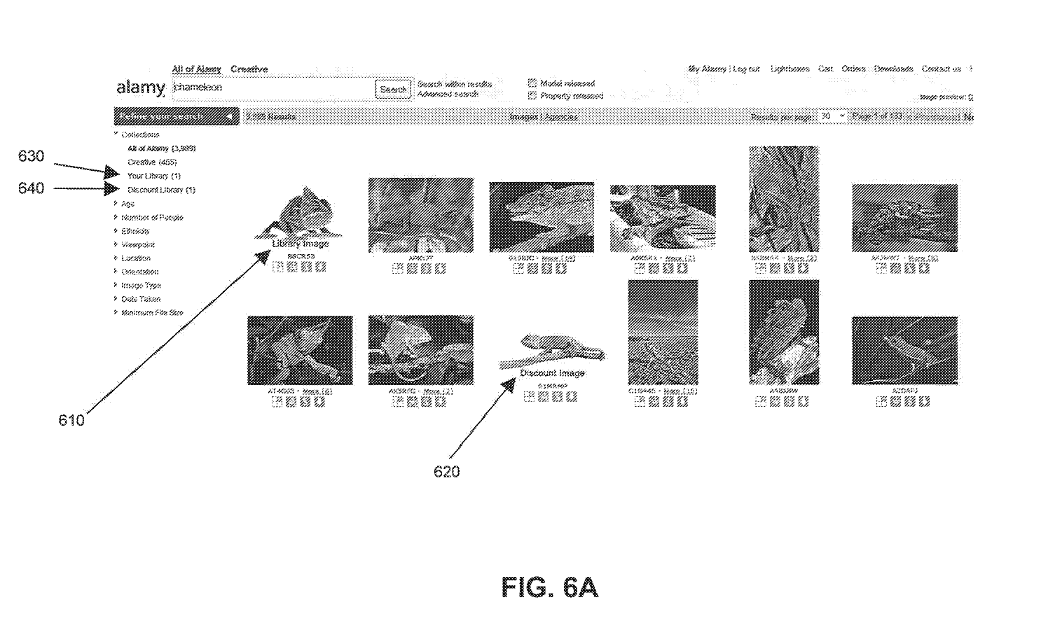

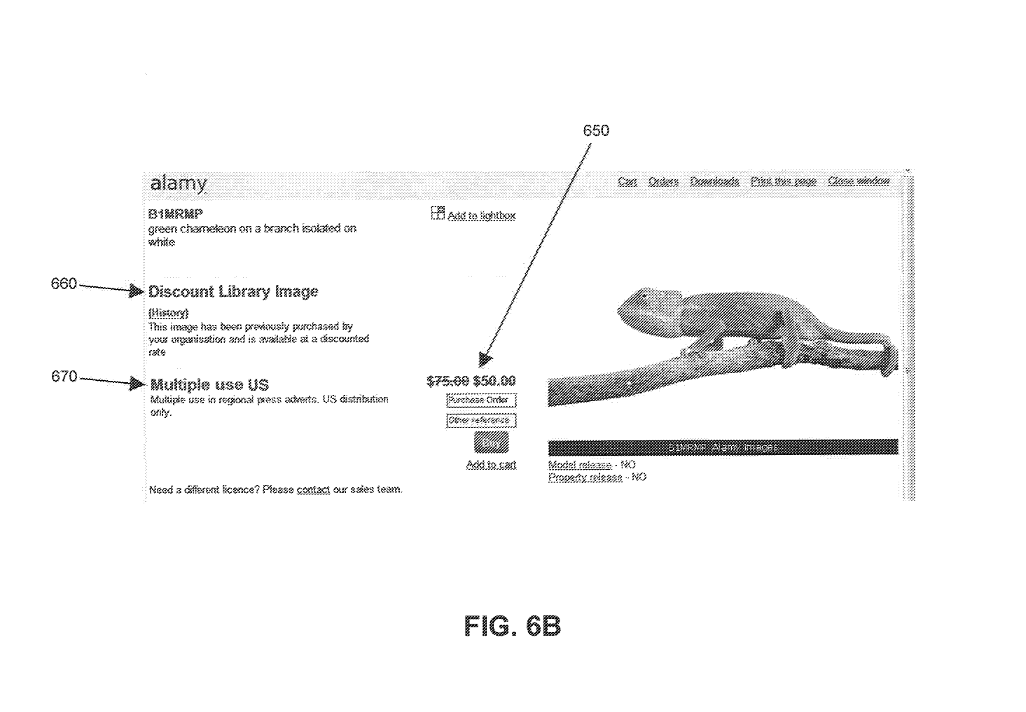

Steps 425 through 440 may be repeated for each retrieved digital media object. For example, it may be determined at step 445 whether the value n is equal to m, the number of retrieved digital media objects. If not, the value n may be incremented by one at step 450, and the process may return to step 425. If the value n is equal to m, the retrieved objects may be displayed to the user at step 455, as illustrated in FIG. 6, for example. In some embodiments, digital media objects may be displayed to the user in an arbitrary order or in accordance with an algorithm. In certain embodiments, a typical search based on user provided terms may return a large number of digital media objects, in which case groups of ten or more digital media objects may be shown together to the user. For example, a large number of digital images may be shown to a user in groups of ten or more “thumbnail” images.

The embodiment of FIG. 6A illustrates a webpage interface to a system incorporating the disclosed systems and techniques showing results of a search for the term “chameleon” in a database of digital stock images. As shown, in some embodiments, one or more of the returned images may be accompanied by one or more informative indicators that convey to a user associated with an organization additional information about the images. Informative indicators may also be used by certain users to, for example, influence the purchases of other users. In some embodiments, a user may determine which informative indicators, if any, are shown and when. In other embodiments, informative indicators may be selected and used by the system based on one or more factors. Factors may include, for example, system-determined brand guidelines or triggering events such as, for example, when nearing a budget or downloading limit.

In some embodiments, the additional information conveyed by informative indicators may be based on, for example, information retrieved and/or derived during the process steps described in FIG. 4 above. For instance, with reference to FIG. 6A, based on the application of one or more licensing models to licensing history data (steps 435 and 440), a “Library Image” label 610 may appear next to corresponding images to indicate, for example, that the images are included in a collection of images labeled “Your Library” 630, which includes only images for which use rights have already been purchased by the organization. Also, based on the application of one or more licensing models to licensing history data (steps 435 and 440), a “Discount Image” label 620 may appear next to corresponding images to indicate, for example, that the images are included in a collection of images labeled “Discount Library” 640, which includes only images available for purchase at a discount (e.g., intra- or inter-node repeat purchase discount). The remaining images are not accompanied by an informative indicator, thereby informing the user that these images are only available at full price (step 430). Thus, in some embodiments, the disclosed techniques may provide a user with the ability to view purchased and/or discounted digital media objects alongside digital media objects that have not been purchased and/or discounted.

The embodiment of FIG. 6B illustrates a webpage interface that may be presented to the user following the selection of the image corresponding to the “Discount image” label 620 in FIG. 6A. In some embodiments, the information provided in the webpage interface of FIG. 6B may be based on information retrieved and/or derived during the process steps described in FIG. 4 above. For example, the interface illustrated in FIG. 6B indicates information retrieved and/or derived from a licensing model including, for example, the discount applied to the purchase price of the image 650, details pertaining to the discount 660, as well as licensing details for the image 670.

In some embodiments, the disclosed systems and techniques may also provide various additional functionalities, as described below. It should be noted that the below description of additional functionalities is not exhaustive and is merely intended for the purpose of illustration.

In some embodiments, the disclosed techniques may enable digital media objects to be searched, and the search results to be organized or filtered based on, for example, the information obtained during the process steps described in FIG. 4 and/or collected metadata (e.g., organizational metadata). For example, digital media object search results may be organized or filtered based on whether the digital media objects have already been purchased or are available for purchase at a discount. As a specific example, referring to FIG. 6A, the “Your Library” collection 630 of digital media objects may include only purchased digital stock images and the “Discount Library” collection 640 of digital media objects may include only discounted digital stock images. Digital media object search results may also be filtered to show only digital media objects purchased by, or available at a discount to, a specific organizational subpart. Other fields by which to organize or filter search results include, for example, how the digital media objects are used, frequency of use, license type, licensing organization and/or organizational subparts, or a combination thereof. For example, a search may be run for images purchased by an associated organization or organizational subpart for use on a book cover. As another example, a user may search for only digital media objects downloaded by an associated organization or organizational subpart within a specific time period. As yet another example, a user may search only for digital media objects purchased by a certain number of users or organizational subparts.

In some embodiments, the disclosed techniques may enable alerts to be setup to support the needs of a user and/or organization or organizational subpart(s). Alerts may notify certain users, for example, that certain digital media objects are available at a discount, that new digital media objects are available for a previously used search term, and that certain licenses are due to expire. In some embodiments, such alerts may be customized to fit the needs of an organization and/or organizational subpart. For example, an alert may be setup to notify certain users of the expiration of critical digital media object licenses. Alerts may appear, for example, on a user's “homepage,” or as some other visual indicator on a user interface, Alerts may also be sent via one or more other means such as, for example, e-mail or text message.

In certain embodiments, the disclosed techniques may also provide users across an organization with collaboration tools. In some embodiments, collaboration tools may allow an organization to, for example, save time and money by sharing resources (e.g., digital media objects, skilled searchers, etc.). For example, collaboration tools may enable users to view the activities (e.g., searches, downloads, and purchases) of one or more other users; see whether other users are online; share a work environment (e.g., search screens); view propagated information (e.g., what is being searched for, downloaded, purchased by an organizational subpart); and create project, work, and/or organizational subgroup spaces. Project, work, and/or organizational subgroup spaces may enable users to, for example, search collaboratively, collaborate synchronously or asynchronously, and score images purchased for use by users associated with a space.

In some embodiments, the disclosed systems and techniques may also provide for live voice, video, and chat communications among users associated with all or part of an organization. In certain embodiments the communications may be recorded and, in some cases, transcribed.

Some embodiments of the disclosed systems and techniques may also provide an audit trail for user(s) and/or all or part of an organization. For example, a system in accordance with the disclosed systems and techniques may record various pieces of information such as, for example, dates of searches, search terms used, actions performed on digital media objects (e.g., zooming in on images), and digital media objects purchased by user(s) and/or all or part of an organization. In some embodiments, an audit trail may also be comprised of digital media object metadata.

The disclosed systems and techniques may also provide digital media object assimilation in some embodiments. In these embodiments, digital media objects may be uploaded, or selected, by a user for analysis by a system in accordance with the disclosed techniques. In some embodiments, system analysis may include, for instance, pattern recognition, fingerprinting, and/or other digital media object analysis techniques used for the purpose of, for example, determining brand guidelines for an organization and/or organizational subpart, conduct searches for digital media objects based on the analysis, and restricting search results based on the analysis. In some embodiments, digital media object metadata may also or instead be used for such purpose. For example, such techniques can be used to locate digital media objects that are similar to ones already searched, purchased, or downloaded by a user and/or all or part of an organization. An organization and/or organizational subpart may also upload brand guidelines information such as, for example, colors, contrast, location of whitespace, and terms relating to a particular subject matter.

In some embodiments, a graphical representation of an organization's structural model and/or licensing model may be viewed and, in some cases, edited, by certain users. In certain embodiments, the graphical representation may also represent activity across the structural model. For example, the graphical representation may show the organization and organizational subparts, price agreements, officers, downloads, size of user libraries, and discount libraries.

In certain embodiments, users may be provided with a real-time view of organizational activity. For example, a real-time view may allow users to see digital media objects arriving in a library containing only purchased digital media objects in real time, or a user may be able to see discounts as soon as they become available. A user may also be able to set flags to notify the user, for example, when digital media objects of a particular type (e.g., author, date, orientation, keywords, subject categories, etc.) arrive in the library or if a discount is available for a particular digital media object or type of digital media object.

The foregoing description of the systems and techniques, along with associated embodiments, has been presented for purposes of illustration only. It is not exhaustive and does not limit the techniques to the precise form disclosed, Those skilled in the art will appreciate from the foregoing description that modifications and variations are possible in light of the above teachings or may be acquired from practicing the techniques. For example, the steps described need not be performed in the same sequence discussed or with the same degree of separation. Likewise, various steps may be omitted, repeated, or combined, as necessary, to achieve the same or similar objectives. Accordingly, the spirit and scope of the techniques described herein should be limited only by the following claims.

What is claimed is:

1. A computer-implemented method for managing digital media objects, the method comprising:
generating a model of an organizational structure comprising a first part and a second part, the model comprising a first structural node representing the first part of the organizational structure and a second structural node representing the second part of the organization structure;
generating a licensing model based on licensing rules that apply to the first and second structural nodes, the licensing model comprising digital media object licensing options corresponding to the first structural node and digital media object licensing options corresponding to the second structural node;
receiving a search query for digital media objects from a user;
determining the user is associated with the first part of the organizational structure;
retrieving at least one digital media object that matches the search query from a data repository;
determining whether the at least one digital media object has been licensed to the first or second part of the organizational structure; and
based on the determination and the licensing model, determining digital media object licensing options available to the user for the at least one digital media object.

2. The method of claim 1, wherein the first part of the organizational structure is a sub-organization, office, or team.

3. The method of claim 1, wherein determining the user is associated with the first part of the organizational structure is based on information provided by the user.

4. The method of claim 1, wherein it is determined that the at least one digital media object has been licensed to the first part of the organizational structure and wherein determining digital media licensing options available to the user for the at least one digital media object is further based on licensing history associated with the at least one digital media object.

5. The method of claim 1, wherein the digital media object licensing options corresponding to the first structural node comprises licensing options inherited from the digital media object licensing options corresponding to the second structural node.

6. The method of claim 1, wherein the digital media object licensing options available to the user for the at least one digital media object includes a discount based on the determination that the at least one digital media object has been licensed to the second part of the organizational structure.

7. The method of claim 1, wherein the digital media object has a profile comprising organizational metadata indicating licensing details corresponding to the digital media object.

8. The method of claim 1, wherein retrieving the at least one digital media object is further based on brand guidelines.

9. The method of claim 8, wherein the brand guidelines are provided by the organization.

10. The method of claim 8, wherein the brand guidelines are determined by analyzing past purchases of digital media objects.

11. The method of claim 1, further comprising:
receiving a search query for digital media objects from a second user;
determining that the second user is associated with a third part of the organizational structure;
editing the model of the organizational structure to include a third structural node representing the third part of the organizational structure; and
editing the licensing model based on licensing rules that apply to the third structural node.

12. A computer system for managing digital media objects, the computer system comprising:
a processor;
a memory coupled to the processor, the memory storing instructions which, when executed by the processor, cause the processor to perform operations comprising:
generating a model of an organizational structure comprising a first part and a second part, the model comprising a first structural node representing the first part of the organizational structure and a second structural node representing the second part of the organization structure;
generating a licensing model based on licensing rules that apply to the first and second structural nodes, the licensing model comprising digital media object licensing options corresponding to the first structural node and digital media object licensing options corresponding to the second structural node;
receiving a search query for digital media objects from a user;
determining the user is associated with the first part of the organizational structure;
retrieving at least one digital media object that matches the search query from a data repository;
determining whether the at least one digital media object has been licensed to the first or second part of the organizational structure; and
based on the determination and the licensing model, determining digital media object licensing options available to the user for the at least one digital media object.

13. The computer system of claim 12, wherein it is determined that the at least one digital media object has been licensed to the first part of the organizational structure and wherein determining digital media licensing options available to the user for the at least one digital media object is further based on licensing history associated with the at least one digital media object.

14. The computer system of claim 12, wherein the digital media object licensing options corresponding to the first structural node comprises licensing options inherited from the digital media object licensing options corresponding to the second structural node.

15. The computer system of claim 12, wherein the digital media object licensing options available to the user for the at least one digital media object includes a discount based on the determination that the at least one digital media object has been licensed to the second part of the organizational structure.

16. The computer system of claim 12, wherein the digital media object has a profile comprising organizational metadata indicating licensing details corresponding to the digital media object.

17. The computer system of claim 12, wherein retrieving the at least one digital media object is further based on brand guidelines.

18. The computer system of claim 17, wherein the brand guidelines are provided by the organization.

19. The computer system of claim 17, wherein the brand guidelines are determined by analyzing past purchases of digital media objects.

20. The computer system of claim 12, further comprising:
receiving a search query for digital media objects from a second user;
determining that the second user is associated with a third part of the organizational structure;
editing the model of the organizational structure to include a third structural node representing the third part of the organizational structure; and
editing the licensing model based on licensing rules that apply to the third structural node.
